(19) United States
(12) Patent Application Publication
(10) Pub. No.: US 2004/0019673 A1
(43) Pub. Date: Jan. 29, 2004

(54) Network management system

(76) Inventors: Keiji Miyazaki, Kawasaki (JP); Yasuki Fujii, Kawasaki (JP); Norihiko Shinomiya, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/612,140

(22) Filed: Jul. 2, 2003

(30) Foreign Application Priority Data
Jul. 10, 2002 (JP) 2002-201098

(51) Int. Cl. G06F 15/173

(52) U.S. Cl. 709/223

(57) ABSTRACT

A network management system in plural networks connected to each other, which offers the improved efficiency and convenience of network maintenance and management. When collecting and managing subnetwork information out of device information as device subnetworks in plural networks connected to each other, a subnetwork manager divides the device subnetwork of a connecting device belonging to the plural networks into plural divided subnetworks corresponding to the plural networks for management. A user interface controls the display of the device subnetworks and plural divided subnetworks.

### BACKGROUND OF THE INVENTION

1. Field of the Invention

This invention relates to a network management system, and more particularly, to a network management system which manages networks.

2. Description of the Related Art

In order to provide various kinds of information network services which have been demanded, we need a complex and huge information infrastructure. The network management increases in importance and the need for improved maintenance control is increasing.

FIG. 18 illustrates the configuration of a network system. This network system 200 is composed of add drop multiplexes (ADMs) 221 to 224 and 231 to 234, element management systems (EMSs) 220, 230, and a network management system (NMS) 210.

Each ADM 221 to 224 and 231 to 234 is a network device which drops and adds a synchronous optical network/synchronous digital hierarchy (SONET/SDH) signal by a certain wavelength with the wavelength division multiplexing (WDM) technique.

Each EMS 220 and 230 is a device management system which manages the corresponding ADMs. The NMS 210 is a network management system which manages the entire network using the EMSs 220 and 230.

The ADMs 221 to 224 are connected in a ring network R20 and the EMS 220 is connected to the ADM 221 to manage the ADMs 221 to 224 of the ring network R20.

Similarly, the ADMs 231 to 234 are connected in a ring network R30 and the EMS 230 is connected to the ADM 231 to manage the ADMs 231 to 234 of the ring network R30.

The NMS 210 is connected to the EMSs 220 and 230 to manage the entire network. Specifically, the NMS 210 obtains and manages the subnetwork information of the ADMs 221 to 224 through the EMS 220 for managing the ADMs of the ring network R20.

Similarly, the NMS 210 obtains and manages the subnetwork information of the ADMs 231 to 234 through the EMS 230 for managing the ADMs of the ring network R30. The subnetwork is information on the management area that each device uses to manage the own device.

In such network system 200 and the ring networks R20 and R30 each comprising only the ADMs have no connection with each other, that is, they are independent. Therefore, the NMS 210 can manage the subnetwork information of the AMDs 221 to 224 and 231 to 234 for each ring network with simple management control.

Recently, however, as the information communication becomes faster and carries a large volume of data many networks are combined and many systems are formed of ring networks connected to each other. FIG. 19 illustrates the configuration of another network system. ADMs 121 to 123 and a cross connect device (XC) 130 are connected in a ring network R20a and similarly ADMs 124 to 126 and the XC 130 are connected in a ring network R20b.

An EMS 120 is connected to the ADMs 121 and 124 and XC 130 to manage the AMDs 121 to 123 and 124 to 126 and XC 130 of the ring networks R20a and R20b. An NMS 110 is connected to the EMS 120 to manage the entire network.

In this network system 100 of FIG. 19, the ring networks R20a and R20b are connected at the XC 130. In such system, the NMS 110 can not manage the subnetworks of the devices for each ring network, which is different from the system of FIG. 18.

This is because the telecommunication management network (TMN: standard to manage plural networks connected to each other) standard defines that any subnetwork to be controlled should not be shared. In the network system 100, since the XC 130 belongs to both the ring networks R20a and R20b and the subnetwork of the XC130, which has been registered for both the ring networks R20a and R20b, is not used for management as it is.

As described above, in the case where plural networks are connected to each other, a subnetwork which belongs to plural networks can not be managed. That is, in this environment, the conventional network management system can not manage the subnetworks for each network, which results in the complicated management control, the deteriorated efficiency and convenience of maintenance control.

### SUMMARY OF THE INVENTION

The present invention has been made in view of the above points, and intends to provide a network management system which offers improved efficiency and convenience of maintenance control by dividing the subnetwork of each device which belongs to plural networks and then managing the networks.

In order to accomplish the above object, there is provided a network management system which manages networks. When collecting subnetwork information from device information and managing them as device subnetworks in plural networks connected to each other, the network management system has a subnetwork manager which divides the device subnetwork of each connecting device belonging to the plural networks into divided subnetworks corresponding to the plural networks and manages them, and a user interface which controls the display of the device subnetworks and divided subnetworks.

The above and other objects, features and advantages of the present invention will become apparent from the following description when taken in conjunction with the accompanying drawings which illustrate preferred embodiments of the present invention by way of example.

### BRIEF DECRIPTION OF THE DRAWINGS

FIG. 1 is a conceptual view of a network management system of this invention;

FIG. 2 illustrates the configuration of a network system;

FIG. 3 illustrates the physical arrangement of devices;

FIG. 4 shows EMS subnetworks;

FIG. 5 shows divided subnetworks;

FIG. 6 shows connection ports of an XC;

FIG. 7 shows a trail termination point;

FIG. 8 shows virtual link ends and a virtual link;

FIG. 9 illustrates the configuration of divided subnetworks;

FIG. 10 is a flowchart which explains how to create divided subnetworks;

FIG. 11 is a flowchart which explains how to cancel the division of divided subnetworks.

FIG. 12 is a view to explain how to make a correspondence among subnetwork connections;

FIG. 13 is a view to explain the mapping processing of subnetwork connections;

FIG. 14 is a flowchart which explains how to perform the mapping processing on subnetwork connections;

FIG. 15 is a flowchart which explains how to delete subnetwork connections;

FIG. 16 shows a network in trouble;

FIG. 17 shows a trouble point on divided subnetworks;

FIG. 18 illustrates the configuration of a network system; and

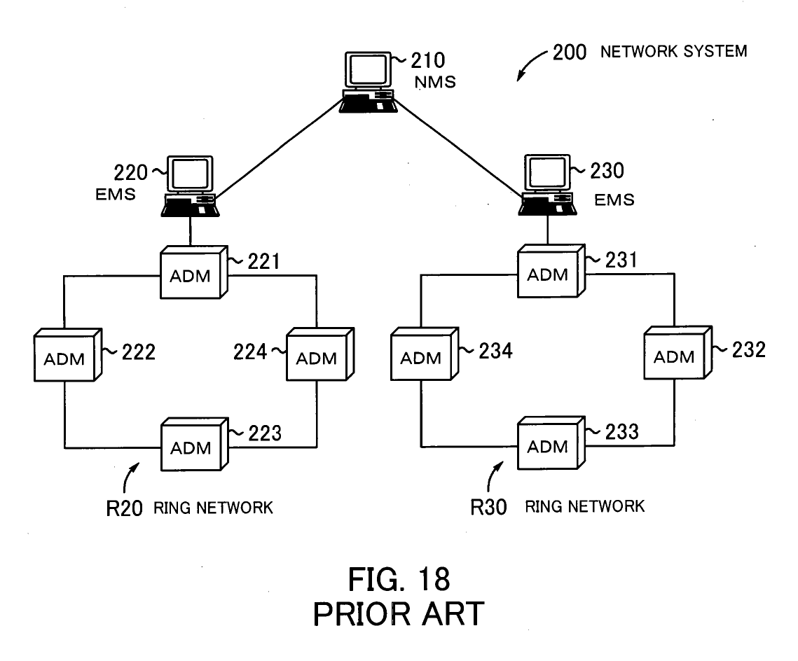

FIG. 19 illustrates the configuration of a network system.

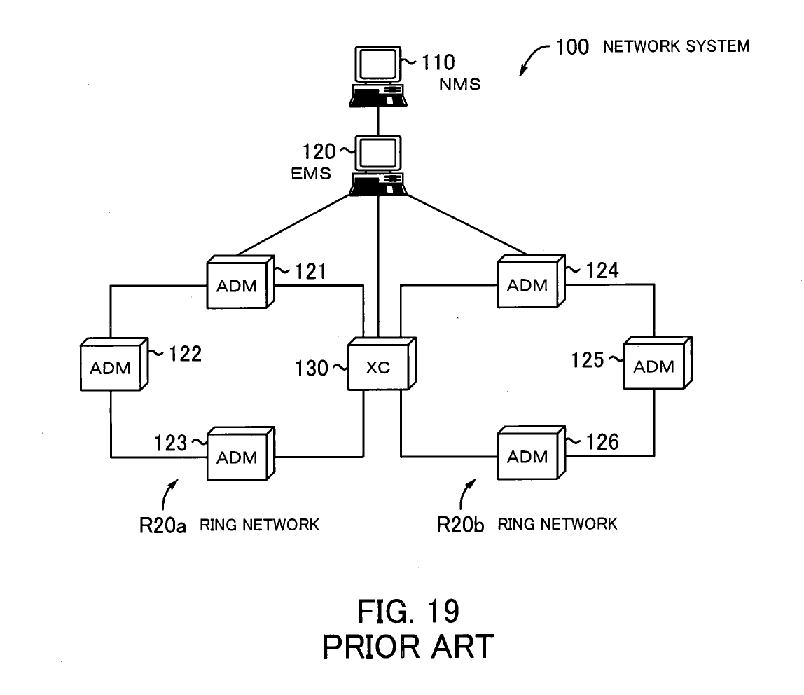

### DESCRIPTION OF THE PREFERRED EMBODIMENTS

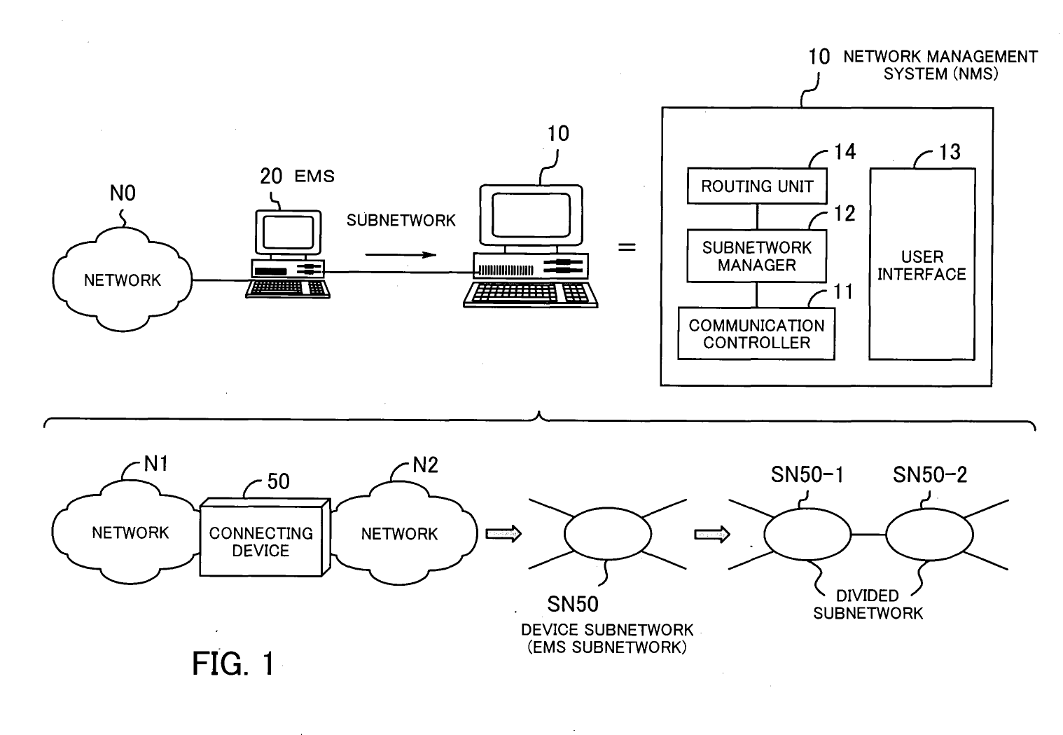

Hereinafter, preferred embodiments of the present invention will be described with reference to the attached drawings. FIG. 1 is a conceptual view of a network management system of this invention. A network management system (NMS) 10 is a system which communicates with an EMS 20 to manage the entire network.

The EMS 20 is a management system which manages information on devices such as network devices (ADM and so on) composing a network N0. And the NMS 10 exists in a higher hierarchy than the EMS 20. The device information is composed of physical information (for instance, information on what-numbered slot of each device contains what package) and logical information (for instance, information on a switch matrix corresponding to the layers of each device). The NMS 10 obtains and manages the logical information (this logical information is subnetwork) out of the device information from the EMS 20.

A communication controller 11 performs interface control for communication with the EMS 20. A subnetwork manager 12 collects the subnetwork information out of the device information and manages them as device subnetworks. The subnetwork represents the switching of a network device as described above. The EMS 20 collects the subnetworks from the network devices, and the NMS 10 obtains the subnetworks from the EMS 20. Especially, the subnetworks to be managed by the NMS 10 are referred to as device subnetworks. In the following description, the device subnetworks are referred to as EMS subnetworks.

In order to manage the EMS subnetworks in plural networks connected to each other, the EMS subnetwork of a connecting device belonging to the plural networks is divided into divided subnetworks corresponding to the respective networks.

Referring to FIG. 1, for example, a connecting device (cross-connect (XC) device) 50 belongs to both networks N1 and N2. In the conventional systems, the subnetwork of the connecting device 50 can not be managed as EMS subnetwork SN50. In this invention, however, the EMS subnetwork SN50 is divided into two so as to correspond to the networks N1 and N2, in order to thereby create a divided subnetwork SN50-1 for the network N1 and a divided subnetwork SN50-2 for the network N2. Then the divided subnetworks SN50-1 and SN50-2 are managed as the subnetworks of the connecting device 50.

In this connection, the subnetwork manager 12 can create the original EMS subnetwork by canceling the division of the divided subnetworks in response to an external command from an operator.

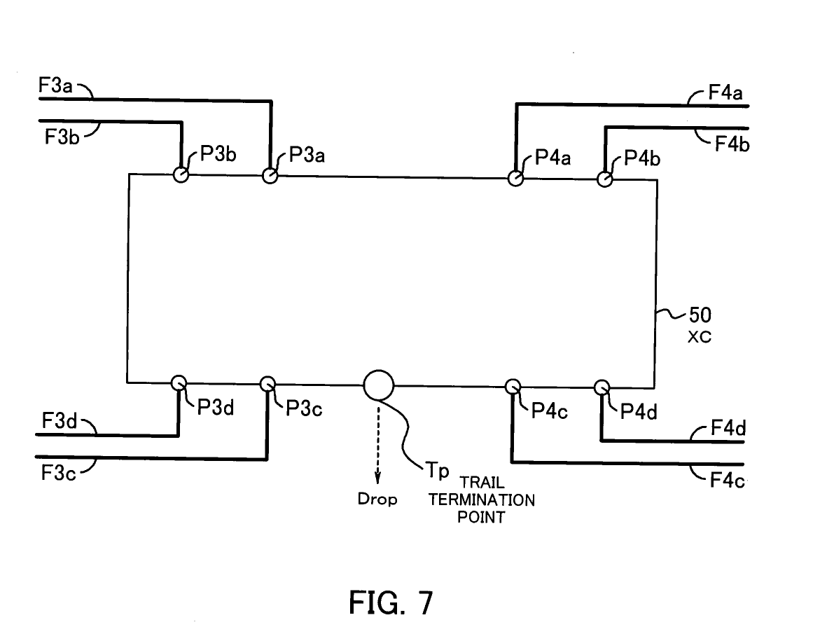

A user interface 13 performs user interface processing on graphical user interface (GUI) for entering commands, controlling the display of device subnetworks and divided subnetworks (including the display of a process of creating a device network or divided subnetworks). A routing unit 14 sets a route between trail termination points (which will be described with reference to FIG. 7 later) on an EMS subnetwork or divided subnetworks.

The next explanation is about a network to be managed by the NMS 10 of this invention, the network formed by connecting widely-used ring networks to each other.

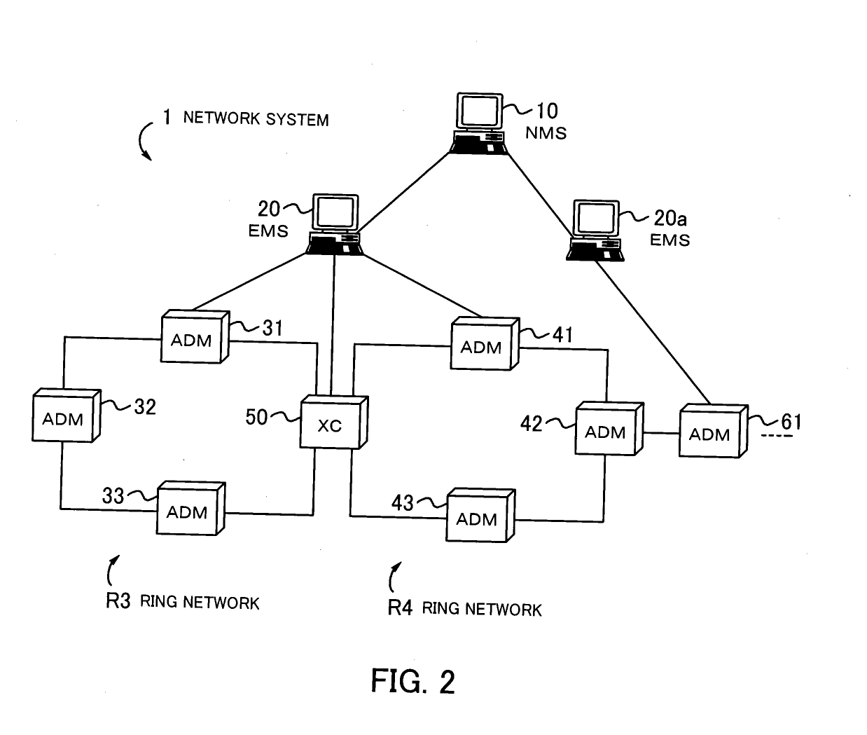

FIG. 2 illustrates the configuration of a network system. The network system 1 is composed of ADMs 31 to 33, ADMs 41 to 43, an XC 50, EMSs 20 and 20a, and an NMS 10.

The ADMs 31 to 33 and the XC 50 are connected in a ring network R3. The ADMs 41 to 43 and the XC 50 are connected in a ring network R4.

The EMS 20 is connected to the ADMs 31 and 41, and the XC 50 to manage the ADMs 31 to 33, ADMs 41 to 43, and XC 50 of the ring networks R3 and R4. In addition, the ADM 42 and an ADM 61 are connected to each other and an EMS 20a manages the ADM 61 (and other ADMs which are not shown and are connected to the ADM 61). The NMS 10 is connected to the EMSs 20 and 20a to manage the entire network.

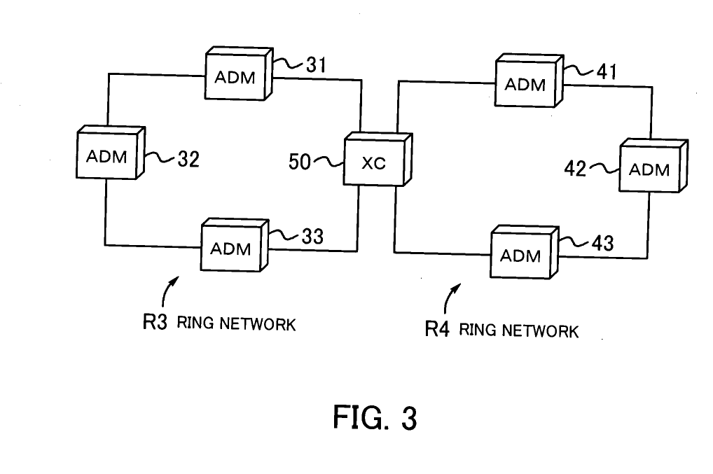

Now, a process of creating divided subnetworks which is performed by the subnetwork manager 12 will be explained with reference to FIG. 3 to FIG. 5. FIG. 3 shows the physical arrangement of devices. The networks of FIG. 3 represent the ring networks R3 and R4 shown in FIG. 2 (see the above description for their configuration).

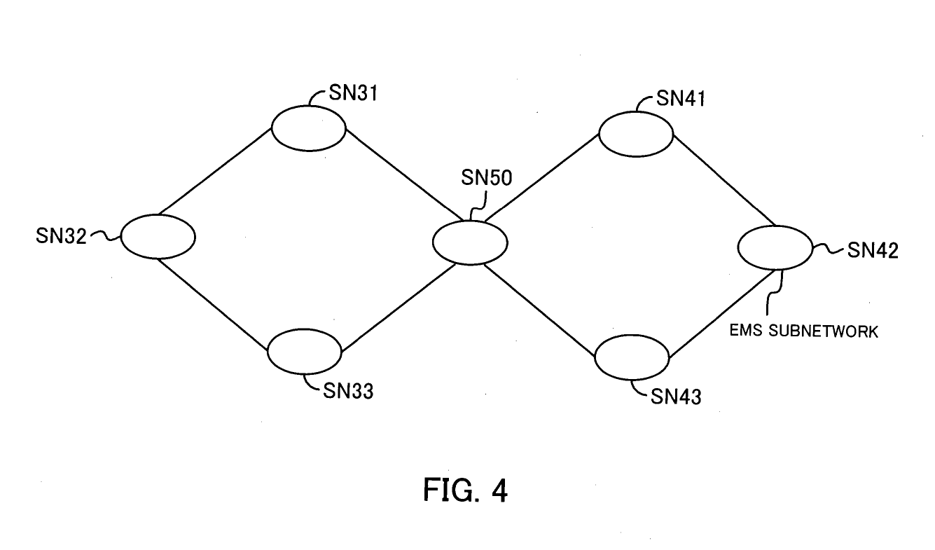

FIG. 4 shows the EMS subnetworks, wherein the function of the same layer which the ADMs 31 to 33, ADMs 41 to 43, and XC 50 of FIG. 3 have is expressed by one subnetwork.

For example, in the case where the function of the same layer is a switching function of virtual container (VC) 3, each EMS subnetwork SN31 to SN33, SN41 to SN43, and SN50 expresses the switching function of the VC 3 that each of the ADMs 31 to 33, ADMs 41 to 43, and XC 50 has.

Therefore, the EMS subnetworks of FIG. 4 correspond to the devices of FIG. 3. That is, the EMS subnetworks SN31 to SN33, SN41 to SN43, and SN 50 correspond to the ADMs 31 to 33, ADMs 41 to 43, and XC 50, respectively.

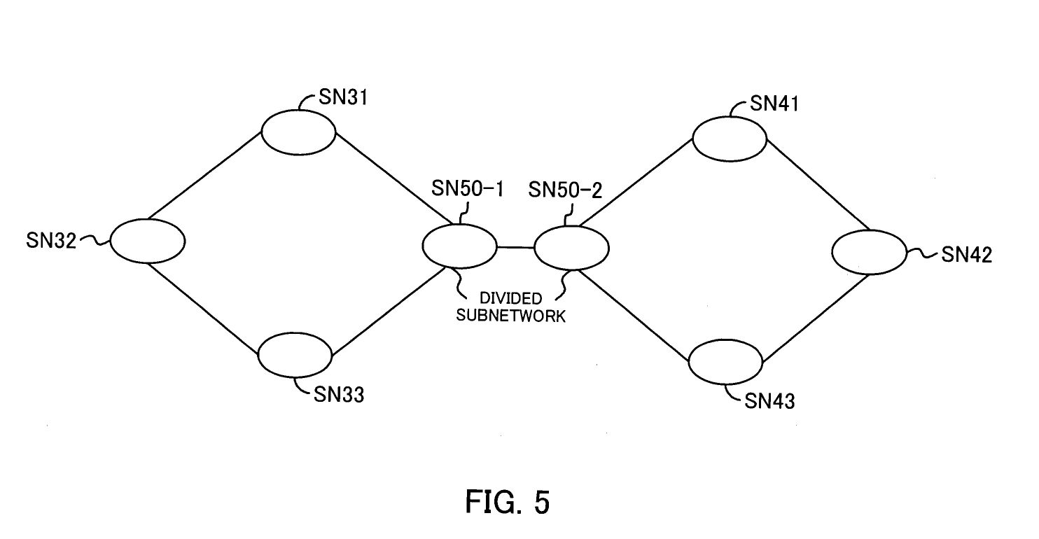

FIG. 5 shows divided subnetworks. Out of the EMS subnetworks of FIG. 4, there exists the EMS subnetwork SN50 which is the subnetwork of the XC50 belonging to both the ring networks R3 and R4. In this case, the network can not be managed as it is.

Therefore, as shown in FIG. 5, the EMS subnetwork SN50 is divided into two to create a divided subnetwork SN50-1 for the ring network R3 and a divided subnetwork SN50-2 for the ring network R4.

In this connection, the subnetwork manager 12 of the NMS 10 holds both the information on subnetworks before division (information on only EMS subnetworks) shown in FIG. 4 and the information on subnetworks after division (information on EMS subnetworks including divided subnetworks) shown in FIG. 5.

Next explanation is about processing necessary for the creation of divided subnetworks. In the case of creating the divided subnetworks SN50-1 and SN50-2 by dividing the EMS subnetwork SN50 as described above, identifiers should be set so as to recognize the correspondence between subnetworks before and after division.

For example, if the reference numerals in this description are used as identifiers as they are, an identifier SN50 is given to the EMS subnetwork before division and identifiers SN50-1 and SN50-2 are given to the divided subnetworks, thereby it can be recognized which EMS subnetwork is divided to create the divided subnetworks.

In addition, when creating divided subnetworks, the subnetwork manager 12 registers connection termination points and trail termination points, and creates virtual link ends and link.

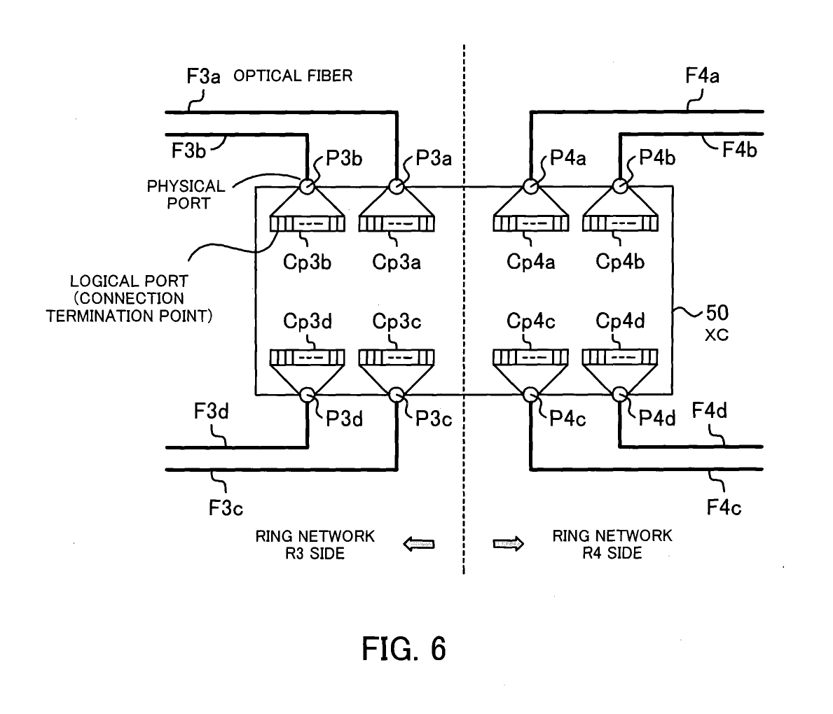

FIG. 6 shows communication ports of the XC 50. The XC 50 has physical ports P3a to P3d and P4a to P4d, which correspond to logical ports Cp3a to Cp3d and Cp4a to Cp4d,respectively. In this connection, plural logical ports exist for one physical port, and these logical ports are called connection termination points (the connection termination points are one of subnetwork information).

The XC50 belongs to both the 2fiber (2F) ring network R3 and 2F ring network R4. Optical fibers F3a to F3d are connected with the physical ports P3a to P3d on the ring network R3 side, while optical fiber F4a to F4d are connected with the physical ports P4a to P4d on the ring network R4 side.

When the subnetwork manager 12 registers the connection termination points, which were created by dividing the EMS subnetwork SN50 of the XC50, it divides the connection termination points between the divided subnetworks SN50-1 and SN50-2.

That is, in this case, the connection termination points Cp3a to Cp3d are points on the ring network R3 side, and therefore the subnetwork manager 12 resisters them as points of the divided subnetwork SN50-1 side. Similarly, the connection termination points Cp4a to Cp4d are points on the ring network R4 side, and therefore the subnetwork manager 12 registers them as points of the divided subnetwork SN50-2 side.

FIG. 7 shows a trail termination point Tp of the XC 50 shown in FIG. 6 (illustration of the connection termination points is omitted). The trail means “pipe” which connects between access points, and the trail termination point means a point to provide service of a layer lower than a high layer (the trail termination point is one of subnetwork information).

For example, if a high layer is the VC3, a point which is connected to a VC2 or VC1 is a trail termination point. Specifically, a Drop point for signals is a trail termination point.

In this connection, the trail termination point Tp of the XC50 is not a port which fixedly belongs to one of the ring networks R3 and R4. The subnetwork manager 12 allows the trail termination point to be used by both the divided subnetworks SN50-1 and SN50-2, which were created by dividing the EMS subnetwork SN50 of the XC50.

That is, the trail termination point Tp is registered as a point for the divided subnetwork SN50-1 of the ring network R3 and also as a point for the divided subnetwork SN50-2 of the ring network R4.

For the case where one of the ring network R3 and R4 actually is using the trail termination point Tp (to drop signals), the subnetwork manager 12 arranges an identifier so as to recognize which ring network is using this point. That is, the trail termination point Tp is given such an identifier and is registered for all the divided subnetworks created through division.

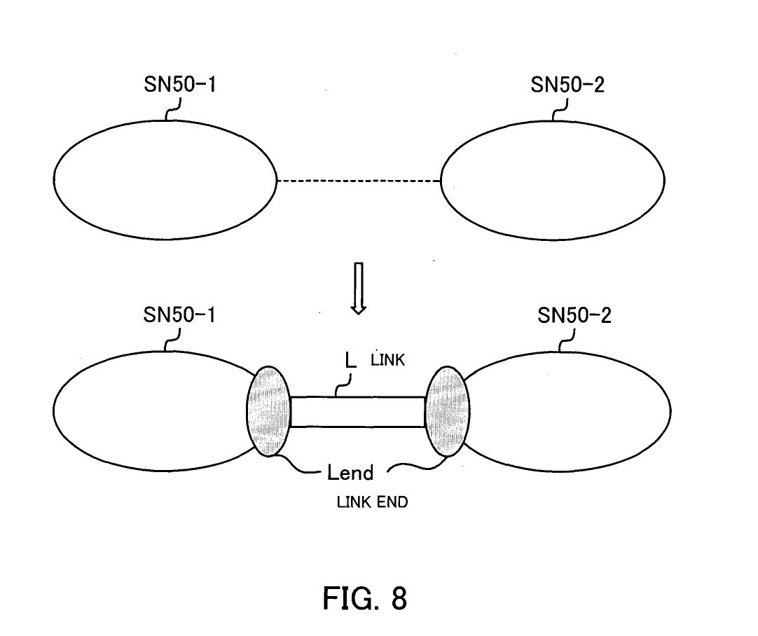

FIG. 8 shows virtual link ends and link. When the subnetwork manager 12 divides the EMS subnetwork SN50 into the divided subnetworks SN50-1 and SN50-2, it creates virtual link ends Lend and a virtual link L between the link ends Lend as shown in FIG. 8. Then the subnetwork manager 12 registers and manages the divided subnetworks SN50-1 and SN50-2 by linking them to each other.

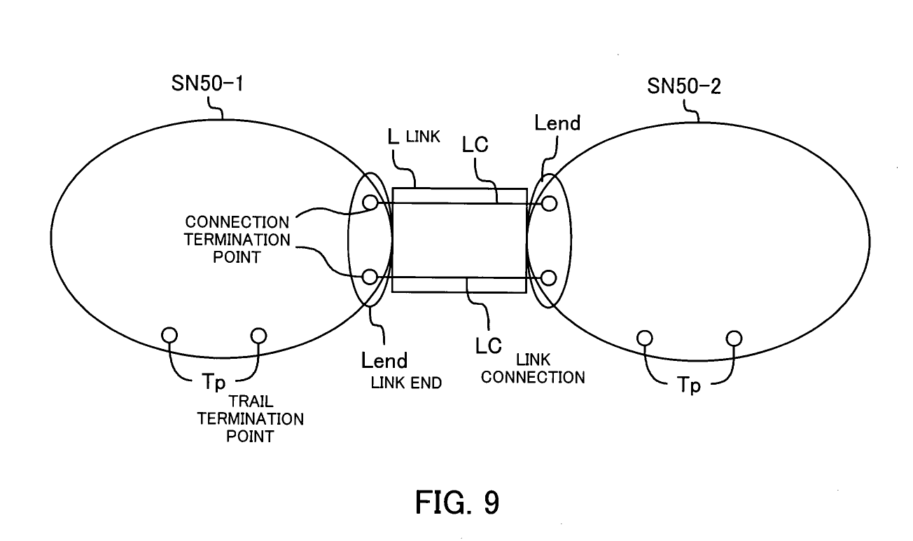

FIG. 9 illustrates the configuration of divided subnetworks. The divided subnetworks SN50-1 and SN50-2 are connected to each other with the link L via the link ends Lend. The link L has connection termination points which are connected with the links LC (a collection of the links LC becomes a link L). In addition, trail termination points Tp exist in the divided subnetworks SN50-1 and SN50-2.

The connection termination points and link connections are created when divided subnetworks are created or when divided subnetwork connections are created (the subnetwork connection describes connectivity in a subnetwork)

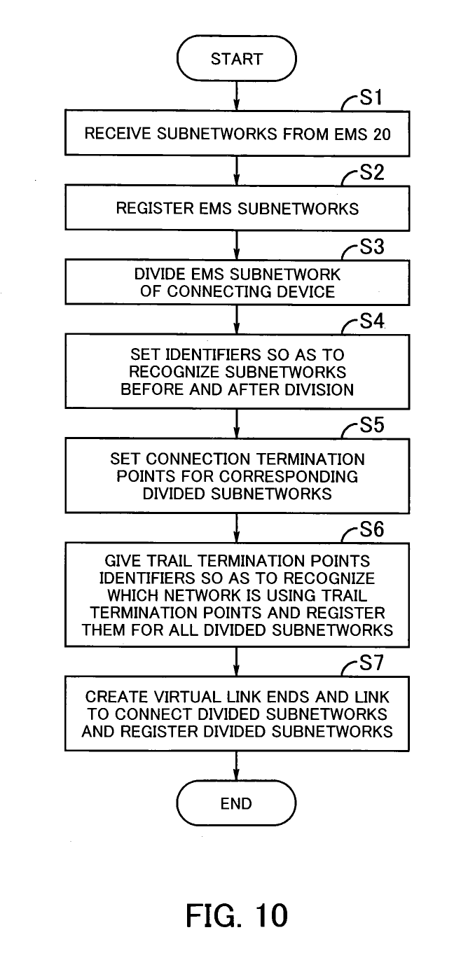

Next, a process of creating divided subnetworks will be described using a flowchart of FIG. 10.

At step S1, the communication controller 11 of the NMS 10 communicates with the EMS 20 and receives the subnetwork of each device.

At step S2, the subnetwork manager 12 registers the obtained subnetworks as EMS subnetworks.

At step S3, when plural networks are connected to each other, the subnetwork manager 12 divides the EMS subnetwork of a connecting device belonging to the plural networks, into divided subnetworks corresponding to the respective networks.

In this connection, this division is performed by the NMS 10 automatically. However, an operator can specify a connecting device which belongs to plural networks so that the subnetwork manager 12 can perform the division.

At step S4, the subnetwork manager 12 registers identifiers so as to recognize the correspondence between the subnetworks before and after division.

At step S5, the subnetwork manager 12 registers the connection termination points for the corresponding divided subnetworks.

At step S6, the subnetwork manager 12 gives each trail termination point an identifier so as to recognize which network is using this trail termination point, and registers it for all the divided subnetworks.

At step S7, the subnetwork manager 12 creates virtual link ends for connection between the divided subnetworks, and also creates a virtual link between the link ends, resulting in connecting the divided subnetworks. Then the divided subnetworks are finally registered.

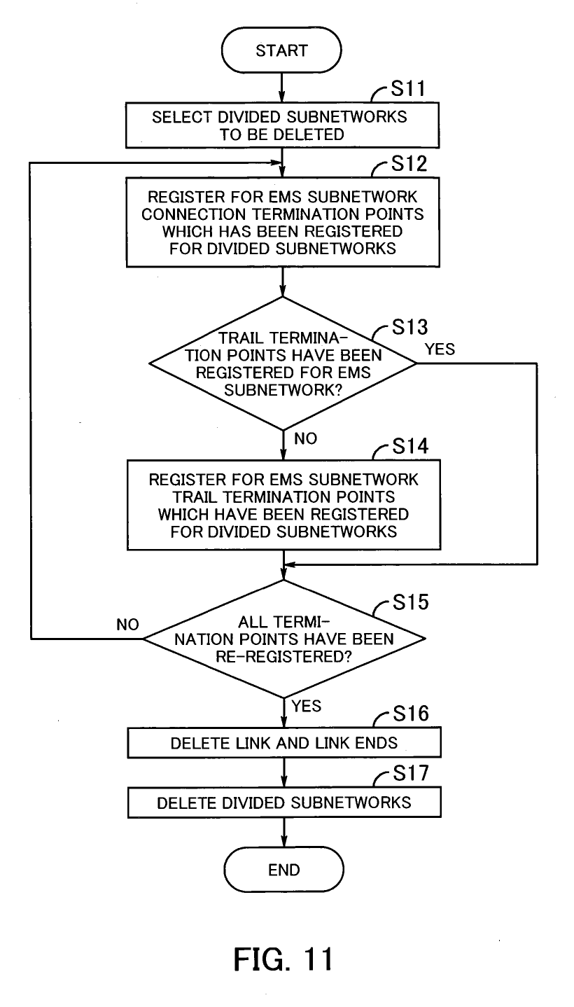

Next, a process of creating the original EMS subnetwork by canceling the division of divided subnetworks will be described following the flowchart of FIG. 11.

At step S11, an operator specifies divided subnetworks to be deleted.

At step S12, the subnetwork manager 12 registers the connection termination points which have been registered for the divided subnetworks, as points of the EMS subnetwork.

At step S13, the subnetwork manager 12 determines whether the trail termination points registered for the divided subnetworks have been registered for the EMS subnetworks. If yes, the process proceeds to step S15; otherwise, the process proceeds to S14.

At step S14, the subnetwork manager 12 registers the trail termination points, which have been registered for the divided subnetwork, as points of the EMS subnetwork.

At step S15, the subnetwork manager 12 determines whether the trail termination points of the divided subnetworks have been all registered for the EMS subnetwork. If yes, the process proceeds to step S16; otherwise, the process returns back to step S12.

At step S16, the subnetwork manager 12 deletes the link and link ends which are connecting the divided subnetworks.

At step S17, the subnetwork manager 12 deletes the divided subnetworks selected at step S11.

As described above, in order to cancel the division of divided subnetworks, the connection termination points, trail termination points are re-registered for the original EMS subnetwork, and then the link and link ends which are connecting the divided subnetworks are deleted and then the divided subnetworks are deleted. In this process, when the trail termination points are re-registered for the EMS subnetwork, a check, like step S13, should be performed so that the same trail termination point is not re-registered several times.

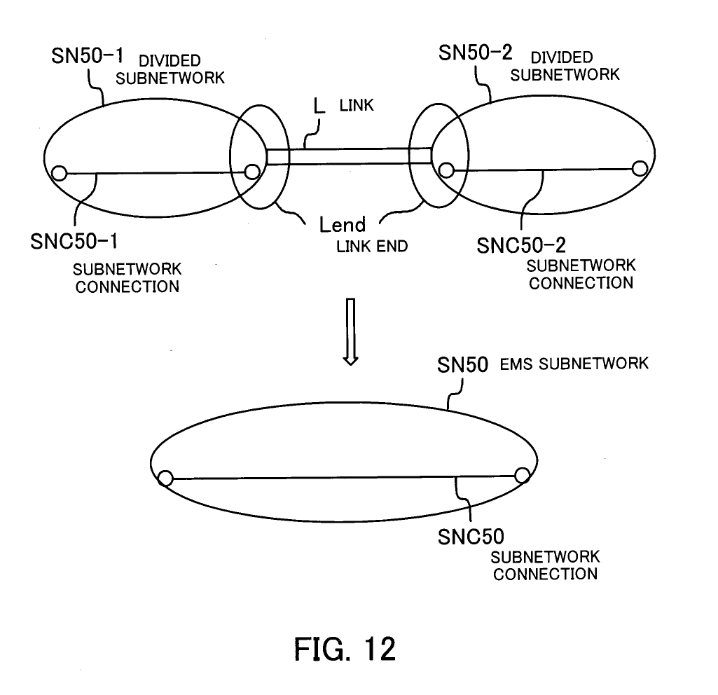

Next, referring to FIG. 12, we will explain how to make a correspondence among the subnetwork connections on an EMS subnetwork and divided subnetworks.

In order to recognize the correspondence between subnetwork connections before and after division, the subnetwork connections of the EMS subnetwork and the divided subnetworks are given identifiers, the subnetwork connection describing the connectivity in a subnetwork.

For example, identifiers SNC50-1 and SNC50-2 are given to the subnetwork connections of the divided subnetworks SN50-1 and SN50-2, respectively, and an identifier SNC50 is given to the subnetwork connection of the EMS subnetwork (corresponding to the subnetwork connections SNC50-1 and SNC50-2), so as to make a correspondence among the subnetwork connections of the divided subnetworks and the subnetwork connection of the EMS subnetwork. It should be noted that the reference numerals in this description are used as identifiers as they are, for simple explanation.

The next explanation is about mapping processing of subnetwork connections. When calculating the shortest route by specifying trail termination points (TTPs) which are ends of the network, an operator enters bandwidth information and protection information between the trail termination points (TTPs) to the NMS 10. Then, the routing unit 14 of the NMS 10 graphs routes between the TTPs and calculates the routes based on the entered information, resulting in obtaining the shortest route between the TTPs.

If thus obtained route is created as a subnetwork connection in an EMS subnetwork, the subnetwork manager 12 creates a subnetwork connection as usual. If the route is created in a divided subnetwork, however, the subnetwork manager 12 registers the subnetwork connection for the divided subnetwork and then maps information on the subnetwork connection to the corresponding EMS subnetwork.

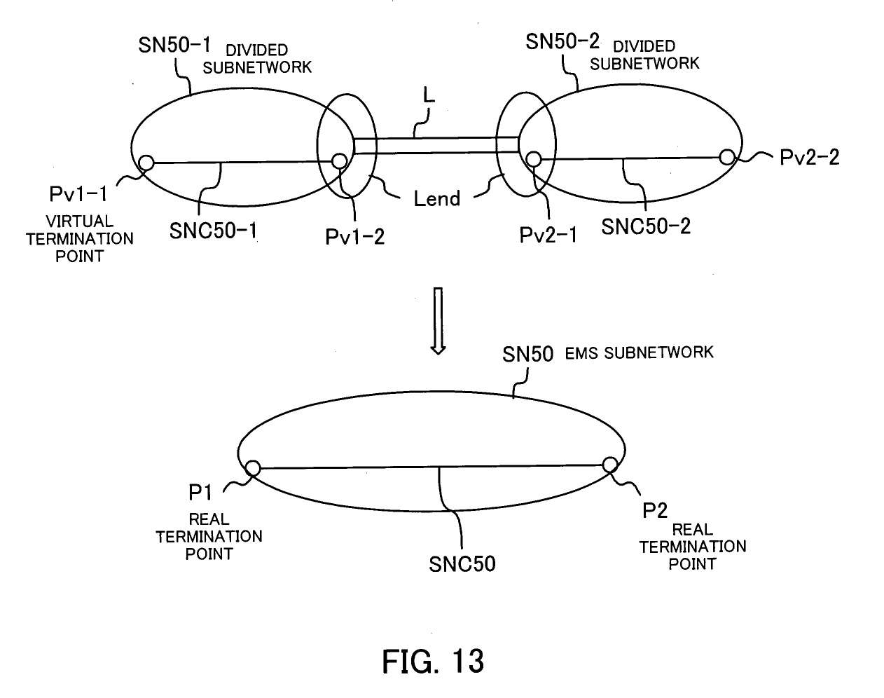

FIG. 13 shows mapping processing of subnetwork connections. A subnetwork connection SNC50-1 has been created so as to connect virtual termination points Pv1-1 and Pv1-2 for the divided subnetwork SN50-1, while a subnetwork connection SNC50-2 has been created so as to connect virtual termination points Pv2-1 and Pv2-2 for the divided subnetwork SN50-2.

In order to map these subnetwork connections SNC50-1 and SNC50-2 to the EMS subnetwork SN50, the subnetwork manager 12 determines whether the virtual termination points Pv1-1, Pv1-2, Pv2-1, and Pv2-2 are actually-used termination points (real termination points) or virtual termination points created when the divided subnetworks were created, and then maps the real termination points to the EMS subnetwork SN50.

In FIG. 13, if the virtual termination point Pv1-1 of the divided subnetwork SN50-1 and the virtual termination point Pv2-2 of the divided subnetwork SN50-2 are real termination points, and the virtual termination point Pv1-2 of the divided subnetwork SN50-1 and the virtual termination point Pv2-1 of the divided subnetwork SN50-2 are virtual termination points, the virtual termination points Pv1-1 and Pv2-2 are mapped to the EMS subnetwork SN50 as the real termination points P1 and P2, resulting in creating an EMS subnetwork connection SNC50.

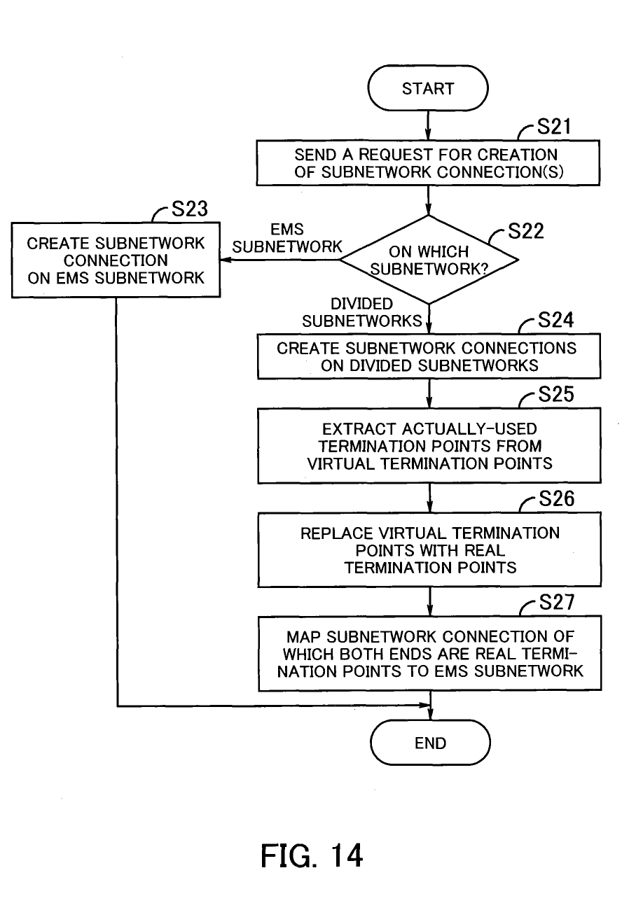

FIG. 14 is a flowchart to explain the mapping processing of subnetwork connections.

At step S21, the routing unit 14 calculates a route and sends the result of routing to the subnetwork manager 12 to request for the creation of a subnetwork connection.

At step S22, the subnetwork manager 12 creates a subnetwork connection(s). At this time, the subnetwork manager 12 determines whether the subnetwork connection(s) is to be created on an EMS subnetwork or divided subnetworks. When it is to be created on the EMS subnetwork, the process proceeds to step S23; otherwise, the process proceeds to step S24.

At step S23, the subnetwork manager 12 creates a subnetwork connection on the EMS subnetwork.

At step S24, the subnetwork manager 12 creates subnetwork connections on the divided subnetworks.

At step S25, the subnetwork manager 12 detects and extracts the actually-used termination points from the virtual termination points on the divided subnetworks.

At step S26, the subnetwork manager 12 replaces the extracted virtual termination points with the real termination points.

At step S27, the subnetwork manager 12 maps a subnetwork connection of which the both ends are the real termination points, to the EMS subnetwork.

Next, the deletion of subnetwork connections will be described. This explanation is for the case where the divided subnetwork connections SNC50-1 and SNC50-2 on the divided subnetworks SN50-1 and SN50-2 created by dividing the EMS subnetwork SN50 are deleted for the subnetwork connection SNC50 on the EMS subnetwork SN50.

At first, the subnetwork manager 12 gives a deletion identifier to each of the divided subnetwork connections SNC50-1 and SNC50-2. Then, when it is determined that the subnetwork connections to be deleted have been all given deletion identifiers, the divided subnetwork connections are deleted. By this deletion processing, plural divided subnetwork connections can be deleted by one operation.

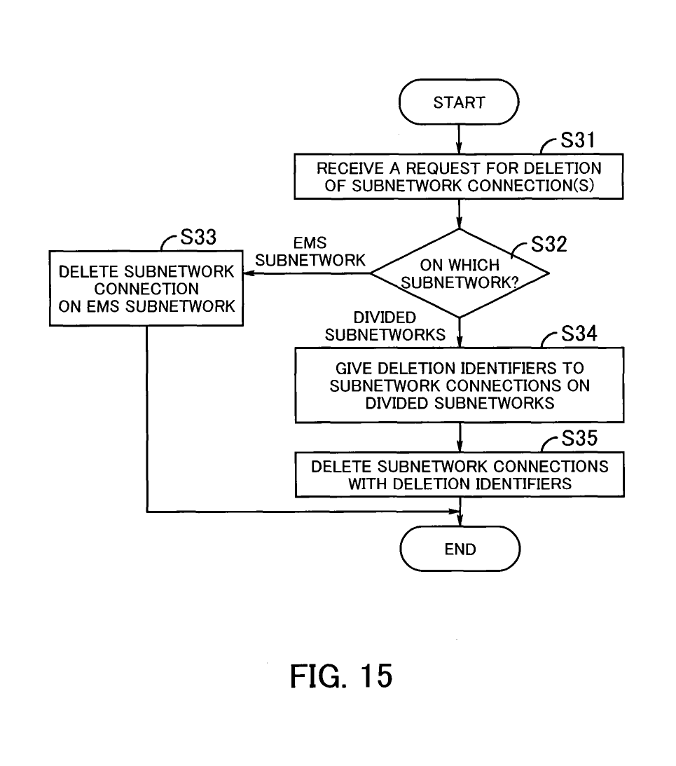

FIG. 15 is a flowchart explaining the deletion processing of subnetwork connection(s) created by the processing shown in FIG. 13 and FIG. 14.

At step S31, the subnetwork manager 12 receives a request for deleting subnetwork connections from an operator.

At step S32, the subnetwork manager 12 determines whether the subnetwork connection(s) are on an EMS subnetwork or divided subnetworks. If on the EMS subnetwork, the processing proceeds to step S33; otherwise, the processing proceeds to step S34.

At step S33, the subnetwork manager 12 deletes the subnetwork connection on the EMS subnetwork.

At step S34, the subnetwork manager 12 gives a deletion identifier to each targeted subnetwork connections of the divided subnetworks.

At step S35, after all the targeted subnetwork connections on the divided subnetworks are given the deletion identifiers, the subnetwork manager 12 deletes all the subnetwork connections with deletion identifiers.

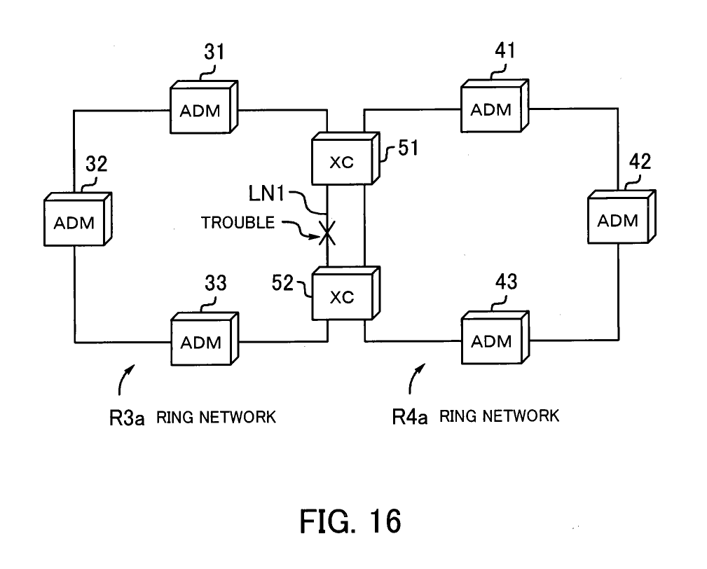

Next, a warning process for the case where trouble occurs on the network will be explained. FIG. 16 shows a network in trouble. The ADMs 31 to 33 and XCs 51 and 52 are connected in a ring network R3a and the ADMs 41 to 43 and the XCs 51 and 52 are connected in a ring network R4a. In addition, a line LN1 connecting the XCs 51 and 52 is in trouble.

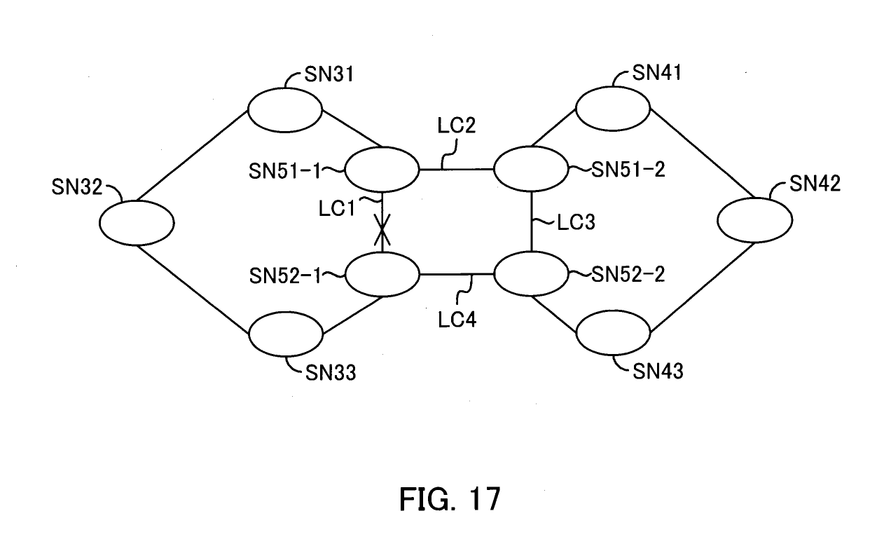

FIG. 17 shows a trouble point on the divided subnetworks. The EMS subnetworks SN31 to SN32 and SN41 to SN43 correspond to the ADMs 31 to 33 and ADMs 41 to 43, respectively. Since the XCs 51 and 52 belong to both the ring networks R3a and R4a, the subnetwork of the XC51 is divided into divided subnetworks SN51-1 and SN51-2. Similarly, the subnetwork of the XC52 is divided into divided subnetworks SN52-1 and SN52-2. The divided subnetworks SN51-1, SN51-2, SN52-1, and SN52-2 are connected to each other with link connections LC1 to LC4.

When trouble occurs on the network (when trouble occurs near an XC connecting the networks), the subnetwork manager 12 detects the link connection corresponding to the line in trouble, from the link connections of the divided subnetworks. Then, the user interface 13 displays a warning for the detected link connection.

In the case where trouble occurs on the line LN1 near the XCs 51 and 52, this line LN1 corresponds to the link connection LC1 of the divided subnetwork. As a result, the user interface 13 displays a warning for the link connection LC1 (for example, by changing a line color of the link connection LC1 or by blinking the link connection LC1).

In the network management of this invention by creating divided subnetworks, even trouble happens near an XC connecting networks, trouble points can be shown by the corresponding link connections created to connect divided subnetworks, so that an operator can surely know which network is in trouble.

As described above, in this invention, the subnetwork expressing a device which belongs to plural networks is divided into plural subnetworks corresponding the plural networks, so as to manage the subnetworks for each network, thus making it possible to offer improved efficiency and convenience of the maintenance and management (for example, the number of nodes in the route search graph can be decreased, resulting in shortening the routing time).

Note that, the above explanation uses the example of ring networks connected to each other as the mutual connection of plural networks. This invention, however, can be applied to the case where networks other than the ring networks are connected to each other.

As described above, the network management system of this invention divides the device subnetwork of a connecting device which belongs to plural networks connected to each other, into divided subnetworks corresponding to the plural networks for management. Thereby, even in the case where plural networks are connected to each other, the subnetwork of each connecting device which belongs to the networks is divided, so as to manage the subnetworks for each network, thus making it possible to offer the improved efficiency and convenience of the maintenance and management.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A network management system for managing networks, comprising:
a subnetwork manager for dividing device subnetwork of a connecting device which belongs to plural networks to be managed, into divided subnetworks corresponding to the plural networks for management when collecting and managing subnetwork information out of device information as device subnetworks in the plural networks connected to each other; and
a user interface for controlling the display of the device subnetworks and divided subnetworks.

2. The network management system according to claim 1, wherein said subnetwork manager sets identifiers so as to recognize the correspondence among the device subnetwork and the divided subnetworks.

3. The network management system according to claim 1, wherein said subnetwork manager registers connection termination points for the corresponding divided subnetwork, while registering trail termination points for all the divided subnetworks after giving each of the trail termination points an identifier so as to recognize which network is using the trail termination point.

4. The network management system according to claim 1, wherein said subnetwork manager creates virtual link ends and link to connect the divided subnetworks.

5. The network management system according to claim 1, wherein, in order to cancel the division of the divided subnetworks in response to an external command, said subnetwork manager registers the connection termination points of the divided subnetworks for the device subnetwork, registers the trail termination points for the device subnetwork, avoiding overlaps, and deletes the link and link ends connecting the divided subnetworks.

6. The network management system according to claim 1, wherein said subnetwork manager sets identifiers so as to recognize the correspondence among the device subnetwork connection and divided subnetwork connections, the device subnetwork connection describing the connectivity in the device subnetwork, the divided subnetwork connections describing the connectivity in the divided subnetworks.

7. The network management system according to claim 1, wherein, when divided subnetwork connections are created, said subnetwork manager finds actually-used termination points from virtual termination points, replaces the found virtual termination points with real termination points, and maps the subnetwork connection of which the both ends are the real termination points, to the device subnetwork.

8. The network management system according to claim 1, wherein, in order to delete divided subnetwork connections, said subnetwork manager gives each of the divided subnetwork connections a deletion flag, and performs the deletion processing when all the divided subnetwork connections have the deletion flags.

9. The network management system according to claim 1, wherein, when creating the divided subnetworks or when creating divided subnetwork connections, said subnetwork manager creates virtual connection termination points and link connections.

10. The network management system according to claim 1, wherein, when trouble occurs on the networks, said subnetwork manager detects a link connection corresponding to a line in trouble from link connections created when the divided subnetworks were created, and said user interface displays a warning for the detected link connection.

11. A network system for managing networks, comprising:
network devices composing the networks;
management systems for managing device information of said network devices; and
a network management system comprising a subnetwork manager for dividing the device subnetwork of a connecting device which belongs to plural networks to be managed, into divided subnetworks corresponding to the plural networks for management when collecting and managing subnetwork information from device information as device subnetworks in the plural networks connected to each other, and a user interface for controlling the display of the device subnetworks and divided subnetworks.

12. The network system according to claim 11, wherein said subnetwork manager sets identifiers so as to recognize the correspondence among the device subnetwork and the divided subnetworks.

13. The network system according to claim 11, wherein said subnetwork manager registers connection termination points for the corresponding divided subnetworks, while registering trail termination points for all the divided subnetworks after giving each of the trail termination points an identifier so as to recognize which network is using the trail termination point.

14. The network system according to claim 11, wherein said subnetwork manager creates virtual link ends and link to connect the divided subnetworks.

15. The network system according to claim 11, wherein, in order to cancel the division of the divided subnetworks in response to an external command, said subnetwork manager registers the connection termination points of the divided subnetworks for the device subnetwork, registers the trail termination points for the device subnetwork, avoiding overlaps, and deletes the link and the link ends connecting the divided subnetworks.

16. The network system according to claim 11, wherein said subnetwork manager sets identifiers so as to recognize the correspondence among the device subnetwork connection and divided subnetwork connections, the device subnetwork connection describing the connectivity in the device subnetwork, the divided subnetwork connections describing the connectivity in the divided subnetworks.

17. The network system according to claim 11, wherein, when divided subnetwork connections are created, said subnetwork manager finds actually-used termination points from virtual termination points, replaces the found virtual termination points to real termination points, and maps the subnetwork connection of which the both ends are the real termination points, to the device subnetwork.

18. The network system according to claim 11, wherein, in order to delete divided subnetwork connections, said subnetwork manager gives each of the divided subnetwork connections a deletion flag, and performs the deletion processing when all the divided subnetwork connections have the deletion flags.

19. The network system according to claim 11, wherein, when creating the divided subnetworks or when creating divided subnetwork connections, said subnetwork manager creates virtual connection termination points and link connections.

20. The network system according to claim 11, wherein, when trouble occurs on the networks, said subnetwork manager detects a link connection corresponding to a line in trouble from the link connections created when the divided subnetworks were created, and said user interface displays a warning for the detected link connection.

21. A network management method for managing networks comprising the steps of:
dividing the device subnetwork of a connecting device which belongs to plural networks, into divided subnetworks corresponding to the plural networks when receiving and managing the subnetworks of devices as device subnetworks in the plural networks connected to each other;
registering identifiers so as to recognize the correspondence between the device subnetworks before and after division;
registering connection termination points for the corresponding divided subnetworks;
registering trail termination points with identifiers for all the divided subnetworks so as to recognize which network is using the points;
creating virtual link ends and a virtual link between the link ends to connect the divided subnetworks; and
registering and managing the divided subnetworks.
